(19) United States
(12) Patent Application Publication
(10) Pub. No.: US 2012/0076589 A1
(43) Pub. Date: Mar. 29, 2012

(54) Method for Decontaminating and Restoring Brown Fields

(76) Inventor: John A. McDonald, Holtsville, NY (US)

(21) Appl. No.: 13/244,456

(22) Filed: Sep. 24, 2011

Related U.S. Application Data
(60) Provisional application No. 61/386,226, filed on Sep. 24, 2010.

(51) Int. Cl. B09C 1/00

(52) U.S. Cl. 405/128.45

(57) ABSTRACT

A method and process for cleaning and recovering brown fields. More specifically, it is the objective of the present invention to introduce a reduced cost process for cleaning and revitalizing brown fields by removing the contaminated soil and refilling with approved filler/reprocessed soil. Contaminated soil is removed from the brown fields and reprocessed into clean soil. Additional soil is removed to create a recessed space. The recessed space is filled with a plurality of tire bales. The clean soil recovered is layered over the plurality of tire bales to complete the newly reformed and recovered piece of land.

The current application claims a priority to the U.S. Provisional Patent application Ser. No. 61/386,226 filed on Sep. 24, 2010.

### FIELD OF THE INVENTION

The present invention relates generally to a process for cleaning and recovering brown fields. More specifically, it is the objective of the present invention to introduce a reduced cost process for cleaning and revitalizing brown fields by removing the contaminated soil and refilling with approved filler/reprocessed soil.

### BACKGROUND OF THE INVENTION

There is an ever-increasing need to address and restore brown fields around the world. A “brown field” site is land that was used for industrial purposes or for commercial uses and is now contaminated with low concentrations of hazardous waste. This land has the potential to be reused, but highly or severely contaminated sites are deemed too hazardous and undesirable to be reused. Current methods exist to remove such hazardous wastes and to restore the land to clean standard conditions. Though, these current methods and means of revitalizing damaged and contaminated land cost a lot of money. Brownfield projects typically use this money not only to purchase the services of removing the contaminated soil but also to purchase outside newer materials from associated companies to fill the emptied land. Furthermore, many of these projects' processes contain byproducts that result in harmful effects to the environment. During the process of cleaning the ground, these projects do long-term damage to the atmosphere by adding pollution and emissions materials. It is therefore an objective of the present invention to introduce a cost-effective process for reusing the contaminated soil to form a clean replacement for the land, reducing the environmental damages. The present invention delegates a large portion of the revenue made from the process to the costs of the invention, making the entire process inexpensive.

### BRIEF DESCRIPTION OF THE DRAWINGS

FIG. 1 shows the process of removing the contaminated soil and excavating the clean soil to create the recessed space to be filled.

FIG. 2 is a view of a fully recovered brown field site, where the recessed space is completely filled with the plurality of tire bales.

### DETAIL DESCRIPTIONS OF THE INVENTION

All illustrations of the drawings are for the purpose of describing selected versions of the present invention and are not intended to limit the scope of the present invention.

The present invention serves to restore lands contaminated by hazardous materials left by industrial factories or other processing facilities. The process of the present invention is a four step process that removes the hazardous materials and clean soil from the brown field creating a space to be filled with reprocessed safe materials and clean soil. The first step of the present invention involves the removal of the contaminated soil. The second step of the present invention is to further dig into the brown field removing a volume of clean soil. The third step of the present invention fills the space left by the removal of the contaminated soils and the clean soils with tire bales. The fourth step of the present invention is the covering and filling of reprocessed soils and clean soil over the tire bales and in between the gaps of the tire bales.

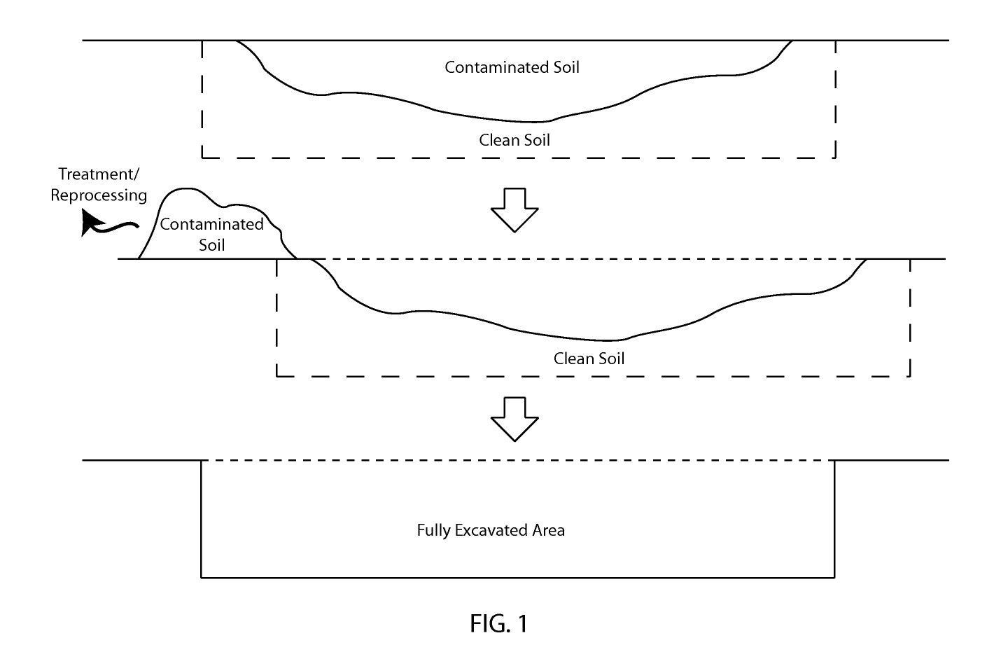

In reference to FIG. 1, given a contaminated site or brown field, the process of the present invention begins with the removal of the contaminated soil. With the hazardous materials either soaked or embedded within the contaminated soil, any area or volume in which the soil is contaminated is dug up and removed. The hazardous material either soaked or embedded within the contaminated soil include metals, pesticides, solvents, explosives, crude oils, and other types of industrial or commercial wastes. The contaminated soils are taken and treated to be reprocessed into clean usable soils. The contaminated can be treated with cleaning processes including soil washing, phytoremediation, soil vapor extraction, in situ oxidation, and other suitable treatments for contaminated soils. In the preferred embodiment of the present invention, the contaminated soil treatment process is phytoremediation. All of the materials, including the hazardous waste, removed from the contaminated soil site are reprocessed with cement and cold mix asphalt paving by the separate phytoremediation process. The cement and cold mix asphalt paving mix serves to immobilize the contaminants and hazardous materials found in the contaminated soils. The liquids waste extracted from the contaminated soils are treated to for the modification of its physical characteristics. The cement is used to chemically bind free liquids, reduce the permeability of waste form, encapsulate waste particles with an impermeable coating, chemically fix hazardous constituents by means of reduced solubility, and reduced toxicity. The end result of the mixture of hazardous material, cement, and cold mix asphalt paving serves to produce reprocessed clean soil.

Once the contaminated soil has been dug up and removed, additional clean soil is dug up and removed to create a properly sized and shaped recessed space. In the preferred embodiment of the present invention, an additional three inches of soil is dug up below the plane of the removed contaminated soil. The removal of the contaminated soil and the clean soil forms a recessed space in the ground. The clean soil that is dug up is later used as a top layer above a filling for the recessed space. This step also further ensures that any and all contaminated soils are removed from the brown field. Additionally, depending on the form of the filling, this step allows the user to shape the recessed space accordingly to efficiently fit the filling.

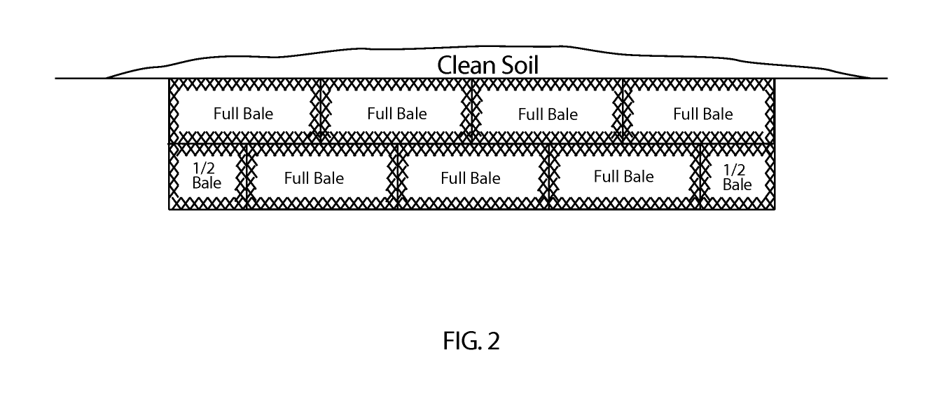

After the desire amount of clean soil is removed, the recessed space is filled with a filling. The filling is to be made from an environmentally neutral material. In the preferred embodiment of the present invention, the filling is a plurality of tire bales. The tire bales are large brick shaped bales comprising used tires found in waste. The tires found in recycling centers are collected, separated, and hydraulically pressed into dense blocks. The tire bales are densely packed and strong enough with the capability to support structures. With the strength and density of tire bales completely filled into the recessed space, any type of structure can be built on top of the newly cleaned field without ground settlement or foundational problems. In reference to FIG. 2, the tire bales used are thirty inches in height. However, the tire bales can be pressed and shaped into any shape to conform to the shape of the recessed space. The tire bales can be formed as full bales or half bales to accommodate the specific volume dug out from the ground as well.

The final step of the present invention involves the covering and layering of the reprocessed clean soil and the clean soil atop of the tire bales. The reprocessed clean soil from the contaminated soil and the clean soil recovered from under the contaminated soil is layered over the plurality of tire bales. Any gaps between the tire bales are also filled with the clean soil and the reprocessed clean soil. Once the clean soil has been layered above the tire bales, the brown field is converted into useable clean land.

The present invention provides environmental benefits in reducing pollution and emissions wastes. With the large number of brown fields present in the United States and around the world, the present invention will create thousands of jobs, leveraged for each and every brown field restoration project. By renewing and restoring the soil of brown fields, surrounding residential property values will be increased. Additionally, by restoring land into usable land, additional opportunities are opened for development. Once a brown field site is cleaned, it can be sold and redeveloped. As a result, the property is placed back on the “property tax role”. This will help provide government funding to help run local systems while lowering taxes for citizens. The present invention additionally complies with many states' policies that require the reusing of products before turning towards new raw materials. It is the main objective of the present invention to reduce and eliminate the cost of running and managing the process. Through the present invention, the funds to clean up all the brown field sites comes from sources that get paid to the end user of the non-hazardous waste material. The end user uses the non-hazardous waste material as the “approved fill”, which allows the cleaning process to be performed for free. It is also another benefit of the present invention to be self-funded.

Although the invention has been explained in relation to its preferred embodiment, it is to be understood that many other possible modifications and variations can be made without departing from the spirit and scope of the invention as hereinafter claimed.

What is claimed is:

1. A method for decontaminating and restoring brown fields comprising the steps in combination of:
removing contaminated soil from a brown field patch, wherein the contaminated soil is dug from the brown field patch;
treating and restoring the contaminated soil into reprocessed clean soil;
digging and removing a layer of clean soil below the contaminated soil;
defining of a recessed space by the removal of the contaminated soil and the clean soil;
filling of the recessed space by a plurality of tire bales;
filling in gaps between the plurality of tire bales with the clean soil and the reprocessed clean soil; and
layering the clean soil and the reprocessed clean soil over the recessed space and the plurality of tire bales.

2. The method for decontaminating and restoring brown fields as claimed in claim 1 comprises,
wherein the treatment of the contaminated soil includes treatment processes including phytoremediation, soil washing, and separation.

3. The method for decontamination and restoring brown fields as claimed in claim 1 comprises,
wherein the recessed space is a rectangular spaced recessed hole; and
wherein the plurality of tire bales are brick shaped bundles of used tires.

4. A method for decontaminating and restoring brown fields comprising the steps in combination of:
removing contaminated soil from a brown field patch, wherein the contaminated soil is dug from the brown field patch;
treating and restoring the contaminated soil into reprocessed clean soil;
digging and removing a layer of clean soil below the contaminated soil;
defining of a recessed space by the removal of the contaminated soil and the clean soil;
filling of the recessed space by a plurality of tire bales;
filling in gaps between the plurality of tire bales with the clean soil and the reprocessed clean soil; and
layering the clean soil and the reprocessed clean soil over the recessed space and the plurality of tire bales.

5. The method for decontaminating and restoring brown fields as claimed in claim 1 comprises,
wherein the treatment of the contaminated soil includes treatment processes including phytoremediation, soil washing, and separation; and
removing hazardous contaminants from the contaminated soil including metals, pesticides, solvents, explosives, or crude oils.

6. The method for decontaminating and restoring of brown fields as claimed in claim 1 comprises,
wherein the recessed space is a rectangular spaced recessed hole; and
wherein the plurality of tire bales are brick shaped bundles of used tires.

7. A method for decontaminating and restoring brown fields comprising the steps in combination of:
removing contaminated soil from a brown field patch, wherein the contaminated soil is dug from the brown field patch;
treating and restoring the contaminated soil into reprocessed clean soil, wherein the treatment of the contaminated soil includes treatment processes including phytoremediation, soil washing, and separation;
removing hazardous contaminants from the contaminated soil including metals, pesticides, solvents, explosives, or crude oils
digging and removing a layer of clean soil below the contaminated soil;
defining of a recessed space by the removal of the contaminated soil and the clean soil, wherein the recessed space is a rectangular spaced recessed hole;
filling of the recessed space by a plurality of tire bales, wherein the plurality of tire bales are brick shaped bundles of used tires;
filling in gaps between the plurality of tire bales with the clean soil and the reprocessed clean soil; and
layering the clean soil and the reprocessed clean soil over the recessed space and the plurality of tire bales.
